(19) United States
(12) Patent Application Publication
(10) Pub. No.: US 2025/0206383 A1
(43) Pub. Date: Jun. 26, 2025

(54) Vehicle Hood Adjustment Devices

(71) Applicant: Gregg Richhart, Woodburn, IN (US)

(72) Inventor: Gregg Richhart, Woodburn, IN (US)

(21) Appl. No.: 18/989,039

(22) Filed: Dec. 20, 2024

Related U.S. Application Data
(60) Provisional application No. 63/612,612, filed on Dec. 20, 2023.

(51) Int. Cl. B62D 25/12; E05D 5/02

(52) U.S. Cl. CPC B62D 25/12; E05D 5/0207; E05Y 2900/536

(57) ABSTRACT

One or more adjustment assemblies for aligning a vehicle hood. These assemblies provide small, incremental adjustments to the hood's hinges, so the hood can be properly aligned. In some cases, the adjustment assemblies include a set screw that allows small adjustments to the position of the hood's hinges by making slight turns to the set screw. The adjustment assemblies allow the hood to be opened and closed to check alignment between adjustments.

### RELATED APPLICATIONS

This application claims the benefit of U.S. Provisional Application Ser. No. 63/612,612 filed Dec. 20, 2023 for “Vehicle Hinge and Hood Adjusters,” which is hereby incorporated by reference in its entirety.

### TECHNICAL FIELD

The present application relates generally to adjustment of a vehicle's hood for proper alignment; and, more particularly, to devices for adjusting the positioning of the hood hinges to properly align the vehicle's hood.

### BACKGROUND

Vehicle hood alignment refers to the positioning of a hood to sit even and be properly aligned with surrounding panels. Proper alignment is important for a clean appearance. Incorrect alignment can be visually unsightly, and lead to difficulties in closing the hood, poor sealing against weatherstripping, and/or potentially damage the hood or surrounding panels.

The primary adjustment points for aligning the hood are the hood hinges. The hood's position can be adjusted by loosening the mounting bolts and slightly repositioning the hinge(s) to raise or lower the hood at specific areas, and then close the hood to inspect whether there are gaps between the hood and fenders, as well as the hood and cowl (the area where the hood meets the front of the car). This process typically takes several attempts because it is easy to overshoot or undershoot adjustments to make the hood flush. This can be an aggravating process, which often times does not result in the hood being perfectly aligned.

Moreover, the adjustment process typically requires two people. When the hood is open, it is on an angle, and with the hinge mounting bolts loosened, the hood will tend to slide up/down on the hinge due to gravity. The adjustment is difficult to do with one person as one must apply enough force on the hood while making adjustments to avoid the hood from sliding. If the hood slides, this could cause damage to the paint. With two people doing the adjustment, one person can stand at the front of the hood to stabilize it so the hood does not slide.

Therefore, there is a need to overcome one or more of these difficulties.

### SUMMARY

This disclosure, in at least one aspect, provides a system for aligning a hood of a vehicle. Typically, the vehicle includes a hood hinge connected to the hood for moving the hood between an open and closed position. Often, the hood hinge includes a hinge mounting plate connected to the underside of a fender and a hinge mounting bracket connected to an underside of the hood. The system includes a first adjustment assembly mountable to the hinge mounting plate and configured to selectively apply a force to an edge of the hinge mounting plate to adjust a position of the hinge mounting plate with respect to the fender. The system also includes a second adjustment assembly mountable to the hinge mounting bracket and configured to selectively apply a force to an edge of the hinge mounting bracket to adjust a position of the hinge mounting bracket with respect to the hood.

In another aspect, this disclosure provides an adjustment assembly for aligning a hood of a vehicle. The adjustment assembly includes a first bracket with a mounting portion configured to mount the first bracket to a hinge mounting plate connected to an underside of a fender. There is a second bracket with an adjustment surface that is movable with respect to the first bracket. The movement of the adjustment surface applies a force to an edge of the hinge mounting plate to move the hinge mounting plate with respect to the fender. In some embodiments, a set screw is configured to control movement of the adjustment surface.

According to a further aspect, this disclosure provides an adjustment assembly for aligning a hood of a vehicle. The adjustment assembly has a bracket with a mounting portion configured to mount the bracket to a hinge mounting bracket connected to the underside of a hood. The adjustment assembly includes an adjustment plate that is movable with respect to the bracket. The movement of the adjustment plate applies a force to an edge of the hinge mounting bracket to move the hinge mounting bracket with respect to the hood. In some embodiments, a set screw configured to the control movement of the adjustment plate.

According to yet another aspect, this disclosure provides a method of aligning a hood of a vehicle. The method includes the step of loosening one or more bolts connecting: (i) the hinge mounting plate to the underside of the fender; and/or (ii) the hinge mounting bracket to the underside of the hood. There is a step of attaching one or more of: (i) a first adjustment assembly to the hinge mounting plate, wherein the first adjustment assembly includes an adjustment surface abutting the edge of the hinge mounting plate; and/or (ii) a second adjustment assembly to the hinge mounting bracket, wherein the second adjustment assembly includes an adjustment plate abutted an edge of the hinge mounting bracket. The method also includes the step of (i) moving the adjustment surface of the first adjustment assembly to apply a force to the edge of the hinge mounting plate to move the hinge mounting plate with respect to the fender; and/or (ii) moving the adjustment plate of the second adjustment assembly to apply a force to the edge of the hinge mounting bracket to move the hinge mounting bracket with respect to the hood.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a front perspective view of an example vehicle with a hood to be adjusted;

FIG. 2 is a left side perspective view of the vehicle shown in FIG. 1 with the hood open to expose one of the hood hinges;

FIGS. 3 and 4 are detailed front perspective views showing a portion of a hood hinge with the mounting bolts connected and some bolts removed, respectively;

FIG. 5 is a side perspective view of a first hood adjustment assembly with the movable adjustment surface in a first position;

FIG. 6 is a side perspective view of the first hood adjustment assembly shown in FIG. 5 with the movable adjustment surface in a second position;

FIGS. 7 and 8 are detailed right and left side perspective views, respectively, showing a plurality of first hood adjustment assemblies installed on a hood hinge;

FIG. 9 is a side perspective view of a vehicle hood prior to alignment adjustment by the first hood adjustment assembly;

FIG. 10 is a side perspective view of the vehicle hood shown in FIG. 9 after adjustment by the first hood adjustment assembly to move the hood so that it is flush with the fender and cowl areas;

FIGS. 11 and 12 are detailed side perspective views showing a portion of a hood hinge;

FIG. 13 is a side perspective view of a second hood adjustment assembly with the movable adjustment surface in a first position;

FIG. 14 is a side perspective view of the second hood adjustment assembly shown in FIG. 13 with the movable adjustment surface in a second position;

FIG. 15 is a left side perspective view showing the second hood adjustment assembly installed on a hood hinge; and

FIG. 16 is a detailed front perspective view showing the second hood adjustment assembly installed on a hood hinge.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

This disclosure solves multiple technical problems. One difficulty with aligning the hood is making micro-adjustments to the hood position, so the hood is completely aligned. In some embodiments, this disclosure includes one or more adjustment assemblies that allow small, incremental adjustments to the hood hinges, so the hood is properly aligned, such as adjustments of 1/16 inch or less. In some cases, the adjustment assemblies include a set screw that allows small adjustments. For example, the user may make a slight turn to the set screw to make a micro adjustment to the hood hinges, and thereby align the hood.

In illustrative embodiments, the adjustment assemblies allow the hood to be opened and closed to check alignment between adjustments. Since the adjustment assemblies hold the hood hinge or hood in place between adjustments, the person making the adjustment can open/close the hood and the adjustment assemblies keep the position of the hinge and hood fixed between adjustments. If the hood is still not properly aligned, the person making the adjustment can make a micro-adjustment, such as by turning the set screw, and recheck the alignment by closing the hood. This significantly reduces the time needed for the hood adjustment. This also allows a single person to adjust the hood hinge, and thereby align the hood, because the adjustment assemblies hold the hinge position between adjustments.

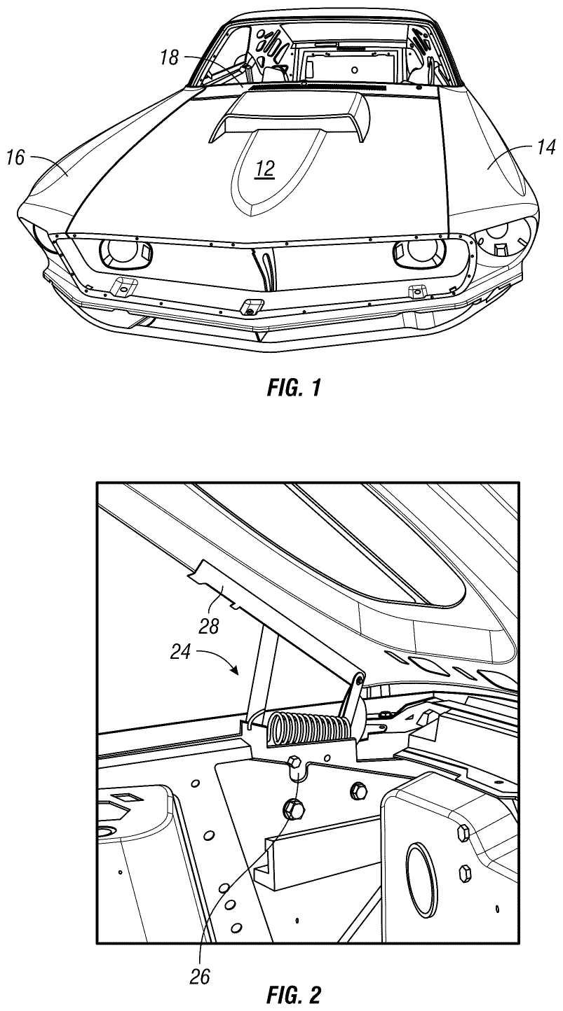

Referring now to FIG. 1, there is shown an example vehicle 10 for which a hood adjustment may be made. Although an automobile is shown for purposes of example, the vehicle 10 could be any type of vehicle with a hood, including but not limited to trucks, SUVs, minivans, convertibles, hatch backs, coupes, station wagons, crossovers and/or sedans. The vehicle 10 includes a hood 12 between a driver-side fender 14 and a passenger-side fender 16. The hood 12 has a front end 18 at the front of the vehicle 10 and a rear end 20 near the cowl 22 of the vehicle 10.

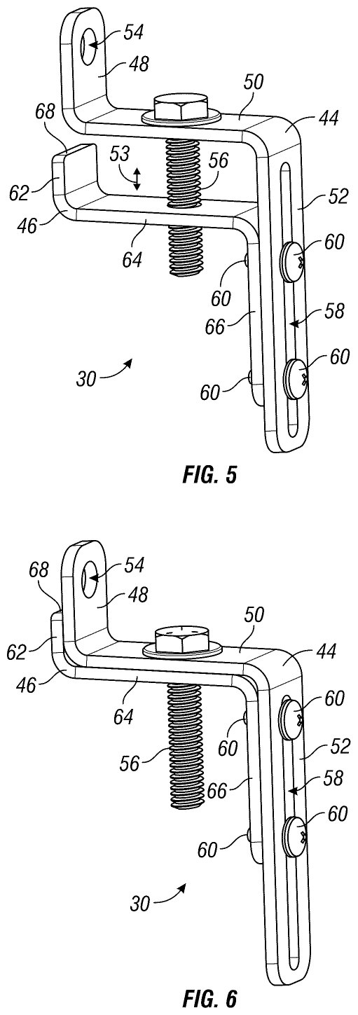

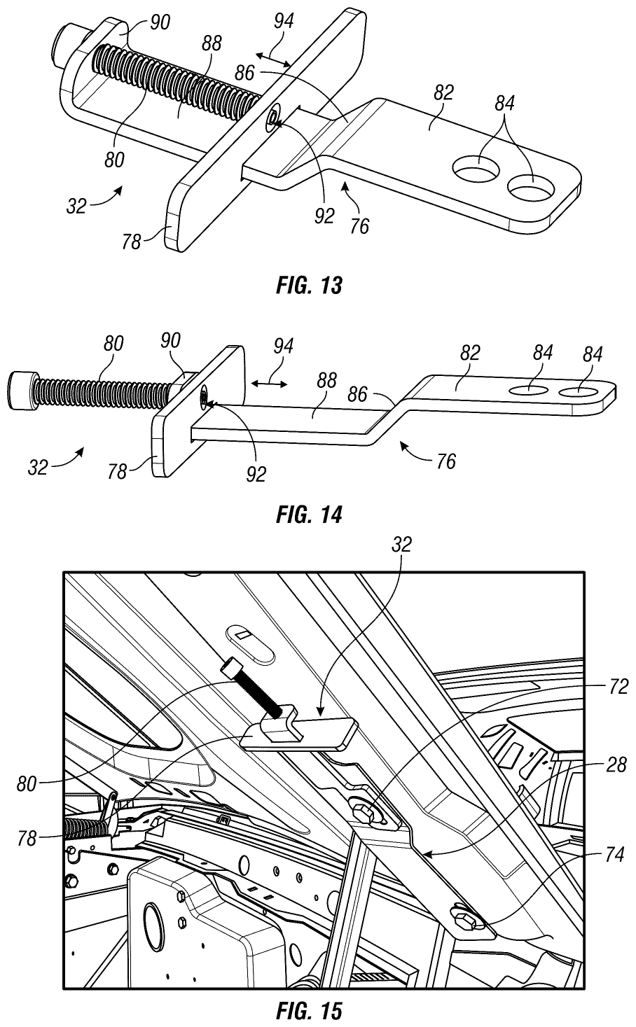

Referring to FIG. 2, the hood 12 is open to expose the hood hinge 24. As shown, the hood hinge 24 includes a hinge mounting plate 26 attached to the underside of the fender 16 and a hinge mounting bracket 28 connected to the underside of the hood 12. According to some embodiments, this disclosure provides a first adjustment assembly 30 (FIGS. 5-6) configured to adjust the position of the hinge mounting plate 26 with respect to the fender 14, which adjusts the position of the hood 12. In some cases, this disclosure provides a second adjustment assembly 32 (FIGS. 13-14) configured to adjust the hinge mounting bracket 28 with respect to the hood 12.

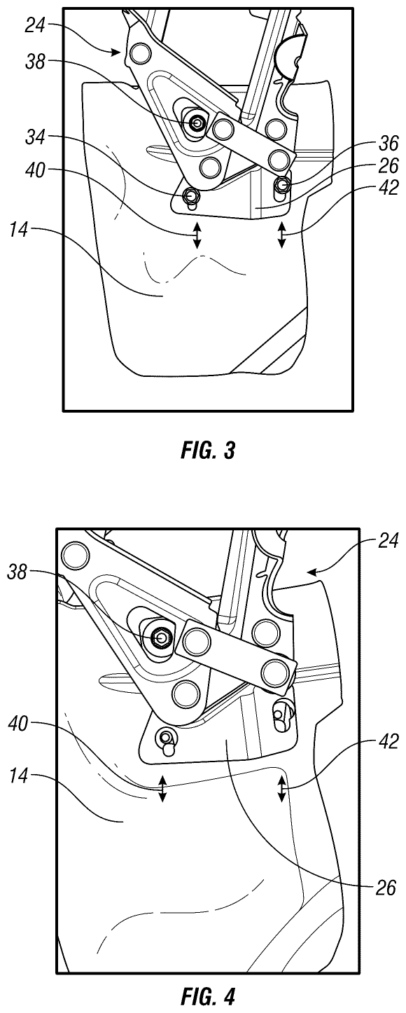

FIGS. 3 and 4 show a detailed view of the hood hinge 24 and the hinge mounting plate 26 connected to the underside of the fender 14 by a first bolt 34, a second bolt 36, and a third bolt 38. To install the first adjustment assembly 30, in the example shown, the user would remove the first bolt 34 and the second bolt 36, and loosen the third bolt 38, as shown in FIG. 4. This allows movement of the hinge mounting plate 26 with respect to the fender 14, as indicated by arrows 40, 42.

FIGS. 5 and 6 illustrate an embodiment of the first adjustment assembly 30 that is configured to adjust the position of the hinge mounting plate 26, thereby adjusting the position of the hood 12. In the embodiment shown, the first adjustment assembly 30 includes a first bracket 44 and a second bracket 46. The brackets 44, 46 may be made of a rigid material, such as metal, hard plastic, wood or the like. For example, in some embodiments, the brackets 44, 46 could be formed from metal that is bent into shape.

In the embodiment shown, the first bracket 44 includes a first leg 48, a second leg 50, and a third leg 52. In the illustrative embodiment, the first leg 48 and third leg 52 are approximately perpendicular to the second leg 50. As shown, the first leg 48 includes an opening 54 to receive one of the mounting bolts 34, 36 to attach the first leg 48 to the hinge mounting plate 26. The second leg 50 includes an opening for a set screw 56 to extend through to the second bracket 46. In the illustrative embodiment, rotation of set screw 56 is configured to control movement of the second bracket 46 toward and away from the first bracket 44 as shown by arrow 53. The term “set screw” is broadly intended to encompass any set screw, set bolt and any other device configured to adjustably control the position of second bracket 46 with respect to the first bracket 44 by interference, pressure and/or friction, including but not limited to a pulley, gear or other device. As shown, the third leg 52 includes a longitudinally-extending slot 58 that receives a plurality of guide bolts 60 that slidably engage the slot 58.

In the embodiment shown, the second bracket 46 includes a first leg 62, a second leg 64, and a third leg 66. In the illustrative embodiment, the first leg 62 and third leg 66 are approximately perpendicular to the second leg 64. As shown, the first leg 62 includes an adjustment surface 68 that is configured to engage an edge of hinge mounting plate 26 such that movement of the adjustment surface 68 causes concomitant movement of the hinge mounting plate 26, thereby adjusting the position of the hood 12. The rotation of the set screw 56 adjusts the position of the adjustment surface 68; accordingly, rotating the set screw 56 adjusts the position of the hinge mounting plate 26, thereby adjusting the hood 12 position, which allows micro-adjustments of the hood. The second leg 64 includes an opening that is axially aligned with the opening in the second leg 50 of the first bracket 44 to receive the set screw 56. As discussed herein, rotation of the set screw 56 moves the second bracket 46 towards or away from the first bracket 44 depending on the direction of rotation. The third leg 66 includes openings to receive the guide bolts 60. As shown, the slot 58 and guide bolts 58 act as a track for the third leg 66 to ride along the third leg 52 as the second bracket 46 moves towards/away from the first bracket 44.

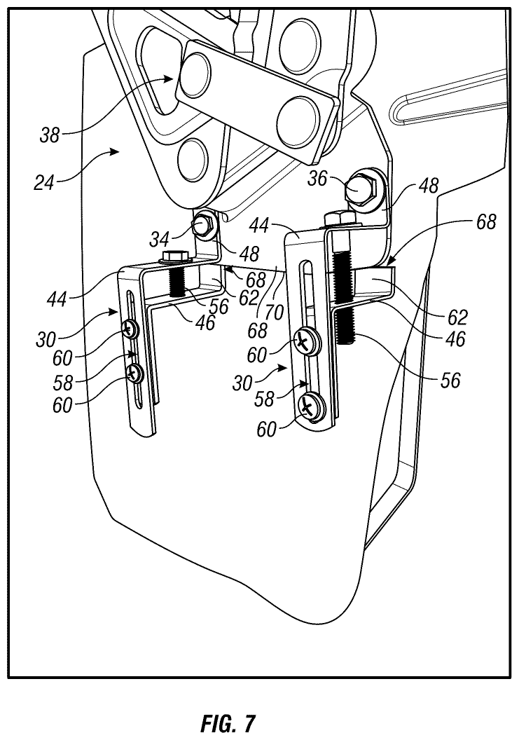

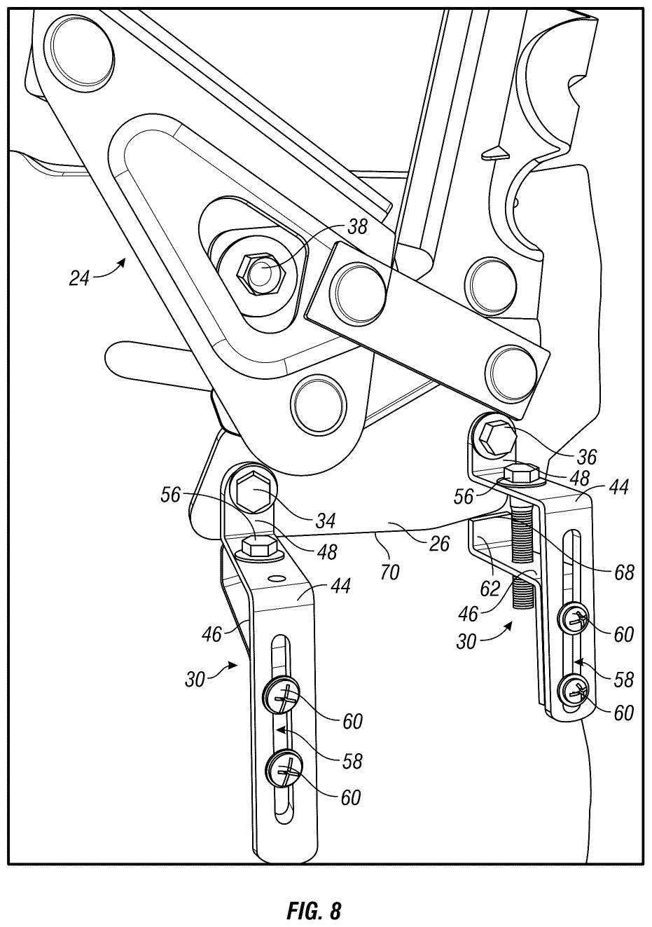

Referring now to FIGS. 7 and 8, there is shown a plurality of first adjustment assemblies 30 installed on a hood hinge 24. Typically, installation is done by loosening the third bolt 38, and removing first and second bolts 34, 36. The bolts 34, 36 are then reinstalled through the opening 54 in the first leg 48 of the first bracket 44 until the bolts 34, 36 are snug, but not fully tight, so the hinge mounting plate 26 can be adjusted in position. The set screw 56 is rotated until the adjustment surface 68 is positioned to abut the edge 70 of the hinge mounting plate 26. With the adjustment surface 68 abutting the edge 70 of the hinge mounting plate 26, the hinge mounting plate 26 is suspended on the adjustment surface 68.

The rotation of the set screw 56 causes movement of the adjustment surface 68, which engages the edge 70 of the hinge mounting plate 26 and provides concomitant movement of the hinge mounting plate 26. By rotating the set screw 56 in a first direction, the hinge mounting plate 26 will move in a first direction (upward as shown) by engagement of the adjustment surface 68 on the edge of the hinge mounting plate 26. Rotation of the set screw 56 in a second direction will move the hinge mounting plate 26 in a second direction (downward as shown) by gravity with the edge of the hinge mounting plate 26 suspended on the adjustment surface 68. Accordingly, with the embodiment shown, rotation of the set screw 56 in different directions can provide upward and downward movement of the hinge mounting plate 26, and thereby upward and downward movement of the hood 12. With two first adjustment assemblies 30 in the example shown, angularly adjustment can be provided by adjusting one of the first adjustment assemblies 30 to cause upward movement of the hinge mounting plate 26 while rotating the set screw 56 in the other first adjustment assembly 30 in an opposite direction to cause downward movement of the hinge mounting plate 26.

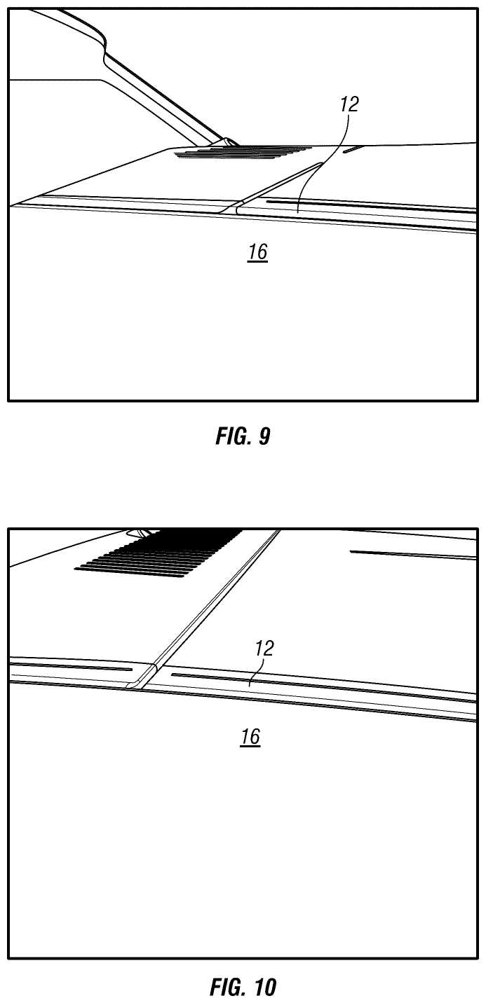

After an adjustment is made by rotating one or both of the set screws 56, the hood 12 can be closed since the first adjustment assemblies 30 maintains the position of the hinge mount plate 26. If the adjustment did not properly align the hood 12, the hood 12 can be opened and one or more of the set screws 56 can be adjusted again. This process can be repeated until the hood 12 is properly aligned. For example, FIG. 9 shows a hood out of alignment that is then aligned in FIG. 10. Once the hood 12 is properly aligned, the bolt 38 and one of the bolts 34 or 36 are tighten down. The other bolt 34 or 36 that has not been tightened down can be removed and the first adjustment assembly 30 removes from that bolt 34 or 36. That bolt 34 or 36 is then tightened down without the first adjustment assembly 30. The other first adjustment assembly 30 may then be removed by removing the other bolt 34 or 36. That bolt 34 or 36 is then tightened down and the hood 12 adjustment is finished with respect to the hinge mounting plate 26 adjustment. Typically, adjustments would be made to both the passenger and driver side hinge mount plates 26.

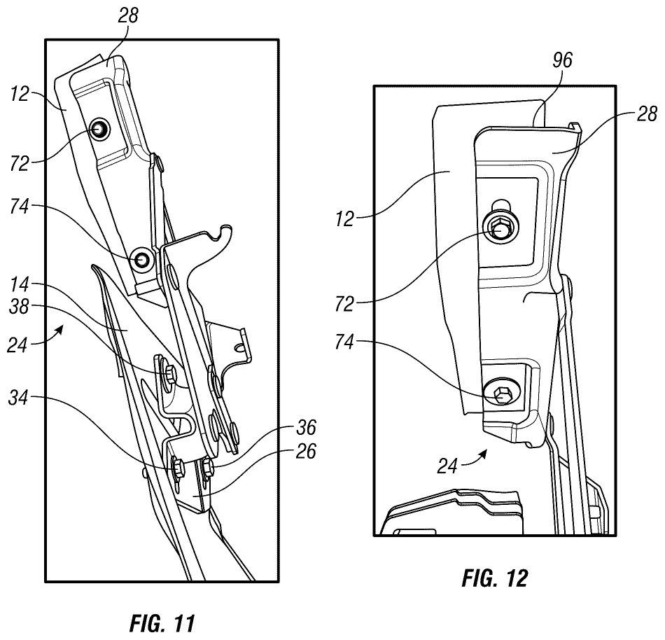

Referring now to FIGS. 11 and 12, there is shown a hood hinge 24 with hinge mounting bracket 28 connected to the underside of the hood 12. As shown, there is a first bolt 72 and a second bolt 74 connecting the hinge mounting bracket 28 to the hood 12. There are slots in the hinge mounting bracket 28 to allow adjustment in position of the hood 12 with respect to the hinge mounting bracket 28 to allow proper alignment of the hood 12.

FIGS. 13 and 14 show an embodiment of the second adjustment assembly 32 that is configured to adjust the position of the hinge mounting plate 28, thereby adjusting the position of the hood 12 (e.g., moving the hood forward and rearward). In the embodiment shown, the second adjustment assembly 32 includes a bracket 76, an adjustment plate 78, and a set screw 80. The bracket 76 and adjustment plate 78 may be made of a rigid material, such as metal, hard plastic, wood or the like. For example, in some embodiments, the bracket 76 could be formed from metal that is bent into shape.

In the embodiment shown, the bracket 76 includes a first segment 82 with a plurality of openings 84. Although two openings 84 are shown for purposes of example a single opening or more than two openings could be protected depending on the circumstances. An angled portion 86 that extends from the first segment 82 to a second segment 88 from which a flange 90 extends. The adjustment plate 78 includes a slot 92 that is dimensioned to receive the second segment 88 of the bracket 76. The adjustment plate 78 is movable between a first position (FIG. 13) and a second position (FIG. 14) based on rotation of the set screw 80 as shown by arrow 94. The rotation of the set screw 80 in a first direction moves the adjustment plate 78 in a first direction and rotation in a second direction moves adjustment plate 78 in a second, opposite direction.

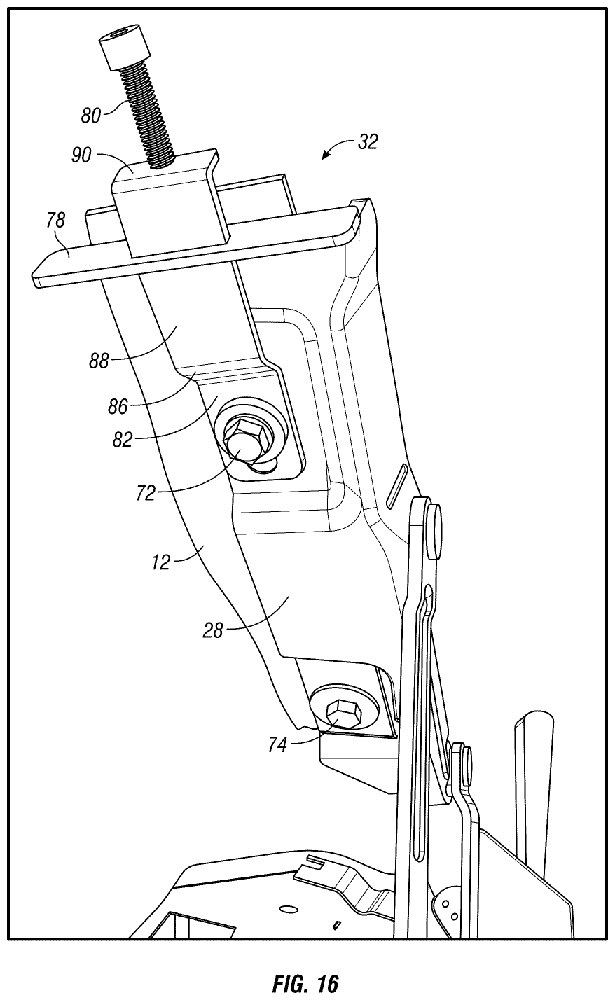

The first segment 82 is configured to be attached to the hinge mounting bracket 28. For example, the first bolt 72 could be removed and reinstalled through one of the openings 84 in the first segment 82 so the second adjustment assembly 32 is attached to the hinge mounting bracket 28. With the bolts snug, but not tight, so the hinge mounting bracket 28 is movable with respect to the hood 12, the adjustment plate 78 is moved to abut an edge 96 (see FIG. 12) of the hinge mounting bracket 28. With this position of the adjustment plate 78, rotating the set screw 80 moves the adjustment plate 78, which causes concomitant movement of the hinge mounting bracket 28 with respect to the hood 12. By rotating the set screw 80 in a first direction, this moves the adjustment plate 78 and hinge mounting bracket 28 in a first direction and by rotating the set screw 80 in a second direction, this moves the adjustment plate 78 and hinge mounting bracket 28 in a second direction. FIGS. 15 and 16 show the second adjustment assembly 32 connected with the hinge mounting bracket 28 to adjust the position of the hood 12 by rotating the set screw 80.

In use, the first bolt 72 is removed and the second bolt 74 loosened. The second adjustment assembly 32 is attached to the hinge mounting bracket 28 using the first bolt 72. The adjustment plate 78 is moved to abut the edge 96 of the hinge mounting bracket 28. When the set screw 80 is rotated, this moves the adjustment plate 78, which applies a force to the edge of the hinge mounting bracket 28 to move the hinge mounting bracket 28, and thereby the hood 12. By rotating the set screw 80 in an opposite direction, this moves the adjustment plate 78, and the hinge mounting bracket 28, in an opposite direction, and thereby adjust the hood 12 position in the opposite direction. Once a desired alignment is reached, the hood 12 can be closed to verify whether the hood 12 is properly aligned. If the hood 12 is not properly aligned, the hood 12 can be opened and the set screw 80 rotated again to adjust the hood 12 position. This process continues until the hood is properly aligned. With the second bolt 74 tightened, the first bolt 72 can then be removed and the second adjustment assembly 32 can be removed. Once the second adjustment assembly 32 is removed, the first bolt 72 can be reattached to the hinge mounting bracket 28. A similar process can be done for both the driver-side and passenger-side hood hinges.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

1. A system for aligning a hood of a vehicle, wherein the vehicle includes a hood hinge connected to the hood for moving the hood between an open and closed position, wherein the hood hinge includes a hinge mounting plate connected to an underside of a fender and a hinge mounting bracket connected to an underside of the hood, the system comprising:
a first adjustment assembly mountable to the hinge mounting plate and configured to selectively apply a force to an edge of the hinge mounting plate to adjust a position of the hinge mounting plate with respect to the fender; and
a second adjustment assembly mountable to the hinge mounting bracket and configured to selectively apply a force to an edge of the hinge mounting bracket to adjust a position of the hinge mounting bracket with respect to the hood.

2. The system of claim 1, wherein the first adjustment assembly is configured to raise and lower a position of the hood.

3. The system of claim 1, wherein the second adjustment assembly is configured to move the hood forward and backward.

4. The system of claim 1, wherein the first adjustment assembly includes an adjustment surface movable between a first position and a second position, wherein the adjustment surface applies a force to the edge of the hinge mounting plate to move the hinge mounting plate with respect to the fender.

5. The system of claim 4, wherein the first adjustment assembly comprises a first bracket with a mounting portion configured to mount the first bracket to the hinge mounting plate and a second bracket with the adjustment surface that is movable with respect to the first bracket.

6. The system of claim 5, wherein the adjustment surface is movable with respect to the first bracket based on rotation of a set screw.

7. The system of claim 6, wherein the first bracket has a first leg with the mounting portion, a second leg through which the set screw extends, and a third leg with an elongated slot through which one or more guide bolts extend.

8. The system of claim 7, wherein the first leg and third leg of the first bracket are approximately perpendicular to the second leg of the first bracket.

9. The system of claim 8, wherein the second bracket has a first leg with the adjustment surface, a second leg through which the set screw extends, and a third leg through which one or more of the guide bolts extend, wherein the guide bolts control lateral movement of the third leg of the second bracket.

10. The system of claim 9, wherein the first leg and the third leg of the second bracket are approximately perpendicular to the second leg of the second bracket.

11. The system of claim 6, wherein the first adjustment assembly is configured to move adjustment surface in a first direction upon rotation of the set screw in a first direction and to move adjustment surface in a second, opposite direction upon rotation of the set screw in a second direction.

12. The system of claim 11, wherein rotation of the set screw in the first direction moves the second bracket towards the first bracket and rotation of the set screw in the second direction moves the second bracket away from the first bracket.

13. The system of claim 1, wherein the second adjustment assembly includes a bracket with a mounting portion configured to mount the bracket to the hinge mounting bracket and an adjustment plate movable with respect to the bracket between a first position and a second position, wherein the adjustment plate applies a force to an edge of the hinge mounting bracket to move the hinge mounting bracket with respect to the hood.

14. The system of claim 13, wherein the adjustment plate is movable with respect to the bracket based on rotation of a set screw.

15. The system of claim 14, wherein the bracket has a first segment with the mounting portion, an angled portion that extends from the first segment to a second segment from which a flange extends.

16. The system of claim 15, wherein the set screw extends through flange and adjustment plate.

17. The system of claim 16, wherein the adjustment plate includes a slot dimensioned to receive the second segment.

18. The system of claim 17, wherein the adjustment plate is configured to ride on the second segment based on rotation of the set screw.

19. The system of claim 18, wherein the first segment includes a plurality of spaced-apart openings configured to receive a fastener for attaching the first segment to the hinge mounting bracket.

20. The system of claim 14, wherein the second adjustment assembly configured to move adjustment plate in a first direction upon rotation of the set screw in a first direction and to move adjustment plate in a second, opposite direction upon rotation of the set screw in a second direction.

21. The system of claim 20, wherein the adjustment plate moves linearly in the first direction and the second direction in response to rotation of the set screw in the first direction and second direction, respectively.

22. An adjustment assembly for aligning a hood of a vehicle, wherein the vehicle includes a hood hinge connected to the hood for moving the hood between an open and closed position, wherein the hood hinge includes a hinge mounting plate connected to an underside of a fender, the adjustment assembly comprising:
a first bracket with a mounting portion configured to mount the first bracket to the hinge mounting plate;
a second bracket with an adjustment surface that is movable with respect to the first bracket, wherein movement of the adjustment surface applies a force to an edge of the hinge mounting plate to move the hinge mounting plate with respect to the fender; and
a set screw configured to control movement of the adjustment surface.

23. An adjustment assembly for aligning a hood of a vehicle, wherein the vehicle includes a hood hinge connected to the hood for moving the hood between an open and closed position, wherein the hood hinge includes a hinge mounting bracket connected to an underside of the hood, the adjustment assembly comprising:
a bracket with a mounting portion configured to mount the bracket to the hinge mounting bracket;
an adjustment plate that is movable with respect to the bracket, wherein movement of the adjustment plate applies a force to an edge of the hinge mounting bracket to move the hinge mounting bracket with respect to the hood; and
a set screw configured to control movement of the adjustment plate.

24. A method of aligning a hood of a vehicle, wherein the vehicle includes a hood hinge connected to the hood for moving the hood between an open and closed position, wherein the hood hinge includes a hinge mounting plate connected to an underside of a fender and a hinge mounting bracket connected to an underside of the hood, wherein the method comprises:
loosening one or more bolts connecting: (i) the hinge mounting plate to the underside of the fender; and/or (ii) the hinge mounting bracket to the underside of the hood;
attaching one or more of: (i) a first adjustment assembly to the hinge mounting plate, wherein the first adjustment assembly includes an adjustment surface abutting an edge of the hinge mounting plate; and/or (ii) a second adjustment assembly to the hinge mounting bracket, wherein the second adjustment assembly includes an adjustment plate abutting an edge of the hinge mounting bracket;
one or more of (i) moving the adjustment surface of the first adjustment assembly to apply a force to the edge of the hinge mounting plate to move the hinge mounting plate with respect to the fender; and/or (ii) moving the adjustment plate of the second adjustment assembly to apply a force to the edge of the hinge mounting bracket to move the hinge mounting bracket with respect to the hood.

25. The method of claim 24, wherein one or more of (i) the adjustment surface is moved by rotating a set screw; and/or (ii) the adjustment plate is moved by rotating a set screw.
